(19) United States
(12) Patent Application Publication
(10) Pub. No.: US 2017/0118312 A1
(43) Pub. Date: Apr. 27, 2017

(54) Packet Header Deflation For Network Virtualization

(71) Applicant: MediaTek Inc., Hsinchu City (TW)

(72) Inventors: Hong-Ching Chen, Kaohsiung City (TW); Kuo-Cheng Lu, Hsinchu City (TW)

(21) Appl. No.: 15/402,132

(22) Filed: Jan. 9, 2017

(51) Int. Cl. H04L 29/06; H04L 12/741

(52) U.S. Cl. CPC H04L 69/04; H04L 69/22; H04L 45/74

(57) ABSTRACT

Examples of packet header deflation for network virtualization are described. A method may involve receiving a data packet having a first length. The method may also involve abbreviating a header of the data packet to deflate the data packet into a deflated data packet having a second length shorter than the first length. The method may further involve forwarding the shortened data packet.

### TECHNICAL FIELD

The present disclosure is generally related to computer networking and, more particularly, to packet header deflation for network virtualization.

### BACKGROUND

Unless otherwise indicated herein, approaches described in this section are not prior art to the claims listed below and are not admitted to be prior art by inclusion in this section.

In streaming applications, the overhead of Internet Protocol (IP), User Datagram Protocol (UDP) and Real-time Transport Protocol (RTP) is 40 bytes for IPv4 and 60 bytes for IPv6. For certain applications such as Voice over IP (VoIP), for example, this overhead tends to take around 60% of the total amount of data sent. Such large overheads may be excessive for certain applications such as, for example, wide area networks (WANs) and wireless systems where bandwidth is scarce. To mitigate the issue of large overhead, there exist some approaches of header compression that compress the header of a data packet from the aforementioned size to a rather small number of bytes.

One approach is context-based header compression, which takes advantage of redundancy in the headers of packets that belong to the same stream. Specifically, fields that are redundant among packets of the same stream are transmitted in the first packet of the stream and omitted in subsequent packets in that stream. Any difference in the header between one packet and a previous packet in the stream is represented by delta encoding. However, this approach is vulnerable to packet errors since an error in one packet can result in errors in subsequent packets in the stream, thereby degrading the reliability of the packets.

Another approach is robust header compression (ROHC). This approach is similar to context-based header compression in that it takes advantage of redundancy in the headers of packets that belong to the same stream. In ROHC, however, a more robust encoding technique such as least significant bit (LSB) encoding is used instead of delta encoding. Nevertheless, this approach tends to require complicated hardware and/or software to implement, resulting in higher cost.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

Implementations in accordance with the present disclosure propose a scheme, as an alternative to existing approaches, in addressing the issue of large overheads. The proposed scheme is a stateless scheme with no error propagation, and is relatively easy for high-speed implementations. Advantageously, the proposed scheme is more efficient in overhead reduction compared to context-based header compression. Moreover, the proposed scheme is also simpler to implement compared to ROHC. Additionally, the proposed scheme can achieve lower usage of packet buffer in a network node (e.g., switch or router) and cross-network bandwidth saving in a network in which the proposed scheme is implemented.

In one example implementation, a method may involve receiving a data packet having a first length. The method may also involve abbreviating a header of the data packet to deflate the data packet into a deflated data packet having a second length shorter than the first length. The method may further involve forwarding the shortened data packet.

In another example implementation, a method may involve receiving a deflated data packet having a first length. The method may also involve restoring a header of the deflated data packet to inflate, or un-deflate, the deflated data packet into an un-deflated data packet having a second length longer than the first length. The method may further involve forwarding the un-deflated data packet.

In yet another example implementation, an apparatus may include a packet header deflation circuit and a buffer. The packet header deflation circuit may be configured to receive a first data packet having a first length. The packet header deflation circuit may also be configured to abbreviate a header of the first data packet to deflate the first data packet into a first deflated data packet having a second length shorter than the first length. The packet header deflation circuit may be further configured to forward the first deflated data packet. The buffer may be coupled to receive and store either the first data packet or the first deflated data packet.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example network architecture in which various techniques and schemes in accordance with the present disclosure may be implemented.

FIG. 3 is a diagram of an example apparatus in accordance with an implementation of the present disclosure.

FIG. 4 is a diagram of an example scenario in accordance with an implementation of the present disclosure.

FIG. 5 is a diagram of an example scenario in accordance with another implementation of the present disclosure.

FIG. 6 is a diagram of an example scenario in accordance with yet another implementation of the present disclosure.

FIG. 7 is a flowchart of an example process in accordance with an implementation of the present disclosure.

FIG. 8 is a flowchart of an example process in accordance with another implementation of the present disclosure.

### DETAILED DESCRIPTION OF PREFERRED EMBODIMENTS

### Overview

Implementations in accordance with the present disclosure may benefit networks such as, for example and not limited to, data center networks (DCNs). A data center is a pool of computational, storage and networking resources interconnected together using a communication network. DCN holds an imperative role in a data center, as the DCN interconnects the data center resources together. In general a DCN needs to be scalable and efficient to connect a great multitude of servers to handle the growing demands of cloud computing. To improve the scalability and efficiency of DCNs, network virtualization technologies may be utilized to combine hardware and software network resources as well as network functionality into a virtual network. Implementations in accordance with the present disclosure may be employed with the network virtualization technology in use in a given network to result in bandwidth saving in cross-network traffic as well as space saving in packet buffer of network nodes in the network.

Some of the examples of network virtualization technologies include Virtual Extensible Local Area Network (VXLAN), Network Virtualization using Generic Routing Encapsulation (NVGRE) and Transparent Interconnection of Lots of Links (TRILL), just to name a few. VXLAN attempts to improve the scalability associated with large cloud computing deployments. VXLAN utilizes a VLAN-like encapsulation technique to encapsulate MAC-based OSI layer 2 (L2) Ethernet frames within layer 4 (L4) UDP packets, and thus extend L2 networks across layer 3 (L3) infrastructure. NVGRE attempts to improve the scalability associated with large cloud computing deployments. NVGRE utilizes Generic Routing Encapsulation (GRE) to tunnel L2 packets over L3 networks. TRILL applies network layer routing protocols to the link layer and uses knowledge of the entire network to support L2 multi-pathing. This enables multi-hop Fiber Channel over Ethernet (FCoE), reduces latency and improves overall network bandwidth utilization.

Implementations in accordance with the present disclosure may be employed with network virtualization technologies such as, for example and not limited to, VXLAN, NGVRE and TRILL. In the interest of brevity and simplicity, examples described herein mainly pertain to VXLAN yet are equally or similarly applicable to other network virtualization technologies such as NVGRE and TRILL. Thus, even though certain implementations in accordance with the present disclosure are described in the context of VXLAN, the scope of the present disclosure is not limited to VXLAN and, rather, extends to other network virtualization technologies, including NVGRE and TRILL, as well as any other suitable technologies.

In accordance with the present disclosure, a VXLAN data packet may be “deflated” into either a deflated data packet. In “deflating” a data packet with a header of a regular length, a network node in which the proposed scheme of the present disclosure is implemented may abbreviate the header of the data packet to result in a deflated data packet with an abbreviated or shortened header. In the context of VXLAN, implementations in accordance with the present disclosure may perform one or more modifications to the header of data packets encapsulated by VXLAN.

In some implementations, as part of the deflation or abbreviation of the header of a data packet, a header type field (herein interchangeably referred to as a profile field) may be inserted in the header of the data packet to indicate the profile of the data packet based on which the data packet is deflated. This profile field may be 8 bits long, or 1 byte, and may contain information such as, for example and not limited to, VXLAN-IPv4 or VXLAN-IPv6 in the context of VXLAN.

In some implementations, as part of the deflation or abbreviation of the header of a data packet, a checksum field and any other fields related to the checksum field (e.g., a length field) may be removed from the header of the data packets.

In some implementations, as part of the deflation or abbreviation of the header of a data packet, one or more static fields may be removed from the one or more outer headers and one or more inner headers of the data packets. This is because each data packet encapsulated by VXLAN may include one or more outer headers and one or more inner headers, and these outer and inner headers may contain one or more static fields the content of which may remain unchanged from one packet to another, at least in the same stream of data packets.

In some implementations, as part of the deflation or abbreviation of the header of a data packet, an inner Organizationally Unique Identifier (OUI) field in one or more inner headers of the data packet may be replaced with an encoded inner identifier field, with the encoded inner identifier field having a length shorter than a length of the inner OUI field. Additionally, as part of the deflation or abbreviation of the header of data packet, an outer OUI field in one or more outer headers of the data packet may be replaced with an encoded outer identifier field, with the encoded outer identifier field having a length shorter than a length of the outer OUI field. This technique takes advantage of the fact that the first three bytes of the L2 Media Access Control (MAC) address encapsulated in VXLAN data packets, which constitute the OUI field, identify the organization (e.g., vendor) that issued the identifier. Accordingly, the 3-byte OUI field may be encoded into and replaced by a shorter encoded identifier field. This technique is applicable at least when the MAC address belongs to a virtual machine.

Alternatively, as part of the deflation or abbreviation of the header of a data packet, the inner OUI field in one or more inner headers of the data packet may be replaced with an encoded inner identifier field, with the encoded inner identifier field having a length shorter than a length of the inner OUI field. Additionally, rather than replacing the outer OUI field in one or more outer headers of the data packet with an encoded outer identifier field, the outer OUI field may simply be removed from the one or more outer headers. This technique may be applicable when the data packets being deflated or abbreviated this way are being forwarded for L3 routing and, hence, there is no need to keep the outer MAC address.

The aforementioned techniques in deflating or abbreviating the headers of data packet may take place in a network node (e.g., switch or router) at the beginning of a path via which a traffic of data packets is forwarded across a network such as DCN. Correspondingly, at the end of the path the headers of data packets may be inflated or restored to the original un-deflated state. Accordingly, a number of operations may be carried out by a network node (e.g., switch or router) at the end of the path in accordance with implementations of the present disclosure.

In some implementations, as part of the inflation or restoration of the header of a data packet, the profile field described above may be removed from the header of the deflated data packet. Moreover, the one or more static fields removed as part of the deflation or abbreviation of the header of the data packet may be inserted back into the header of the deflated data packet.

In some implementations, as part of the inflation or restoration of the header of a data packet, the checksum field and any other fields related to the checksum field (e.g., a length field) removed as part of the deflation or abbreviation of the header of the data packet may be inserted back into the header of the deflated data packet.

In some implementations, as part of the inflation or restoration of the header of a data packet, the encoded inner identifier field described above may be removed and replaced by the inner OUI field that was removed as part of the deflation or abbreviation of the header of the data packet. Likewise, the encoded outer identifier described above may be removed and replaced by the outer OUI filed that was removed as part of the deflation or abbreviation of the header of the data packet.

In some implementations, for data packets forwarded for L3 routing and as part of the inflation or restoration of the header of a data packet, the encoded inner identifier field described above may be removed and replaced by the inner OUI field that was removed as part of the deflation or abbreviation of the header of the data packet. Furthermore, the outer OUI field that was removed as part of the deflation or abbreviation of the header of the data packet may be inserted back into the outer header of the data packet.

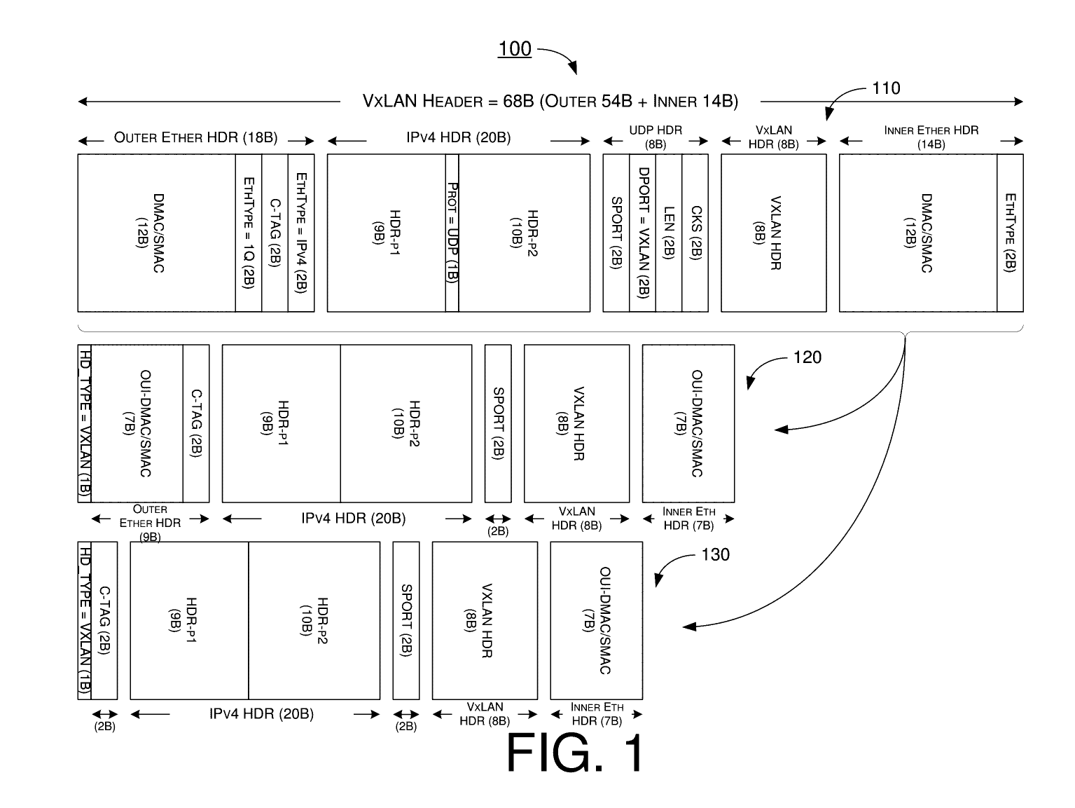

FIG. 1 illustrates an example scenario 100 in accordance with an implementation of the present disclosure. In scenario 100, a VXLAN data packet header 110 of a VXLAN data packet may be deflated or otherwise abbreviated into a deflated header 120. Alternatively, VXLAN data packet header 110 may be deflated or otherwise abbreviated into a deflated header 130 when VXLAN data packet is forwarded for L3 routing. In the example shown in FIG. 1, VXLAN data packet header 110 has 68 bytes comprised of 18 bytes of outer Ethernet header, 20 bytes of IPv4 header, 8 bytes of UDP header, 8 bytes of VXLAN header and 14 bytes of inner Ethernet header. In deflating or abbreviating the VXLAN data packet header 110 into deflated header 120 or deflated header 130, a number of operations may be carried out with respect to some of the fields contained in VXLAN data packet header 110.

As shown in FIG. 1, one or more static fields contained in each of outer Ethernet header, IPv4 header, UDP header and inner Ethernet header may be removed as part of the deflation or abbreviation of VXLAN data packet header 110. For instance, the two 2-byte Ethernet type fields (EthType) in outer Ethernet header may be removed; the 1-byte protocol header in IPv4 header may be removed; the 2-byte destination port (DPORT) field in UDP header may be removed; and the 2-byte Ethernet type field (EthType) in inner Ethernet header may be removed.

As shown in FIG. 1, a checksum field and any other fields related to the checksum field (e.g., a length field) may be removed from the header of the data packets as part of the deflation or abbreviation of VXLAN data packet header 110. For instance, the 2-byte checksum field (CKS) as well as the 2-byte length field (LEN) in UDP header may be removed.

As shown in FIG. 1, a 1-byte header type field or profile field (HD_TYPE) may be inserted in the header of the deflated data packet to indicate the profile of the data packet based on which the data packet is deflated. This profile field may contain information such as, for example and not limited to, VXLAN-IPv4 or VXLAN-IPv6 in the context of VXLAN.

As shown in FIG. 1, the OUI in the OUI field in the MAC address contained in the 12-byte destination MAC address/source MAC address field (DMAC/SMAC) in outer Ethernet header may be encoded into a much shorter identifier (e.g., 4-bit length). As a result, the original DMAC/SMAC field in outer Ethernet header may be abbreviated to a shorter length (e.g., 7 bytes) identifier, shown in FIG. 1 as an OUI-DMAC/SMAC field in outer Ethernet header in deflated header 120. Similarly, the OUI in the OUI field in the MAC address contained in the 12-byte DMAC/SMAC field in inner Ethernet header may also be encoded into a much shorter identifier (e.g., 4-bit length). As a result, the original DMAC/SMAC field in inner Ethernet header may be abbreviated to a shorter length (e.g., 7 bytes) identifier, shown in FIG. 1 as an OUI-DMAC/SMAC field in inner Ethernet header in deflated header 120.

Alternatively, when the VXLAN data packet is forwarded for L3 routing, the OUI in the OUI field in the MAC address contained in the 12-byte destination MAC address/source MAC address field (DMAC/SMAC) in outer Ethernet header may be encoded into a much shorter identifier (e.g., 4-bit length). As a result, the original DMAC/SMAC field in outer Ethernet header may be abbreviated to a shorter length (e.g., 7 bytes) identifier, shown in FIG. 1 as an OUI-DMAC/SMAC field in outer Ethernet header in deflated header 130. However, rather than encoding the OUI in the OUI field in the MAC address contained in the 12-byte DMAC/SMAC field in inner Ethernet header into a shorter identifier, the outer OUI field or the entire DMAC/SMAC field may be removed from outer Ethernet header of deflated header 130, as shown in FIG. 1. This results in deflated header 130 being even shorter than deflated header 120 for cases such as when the VXLAN data packets are forwarded for L3 routing.

Accordingly, implementations in accordance with the present disclosure are relatively low-cost as there is no need to store context in memory of network nodes as with context-based header compression. Also, compared to header compression approaches, implementations in accordance with the present disclosure provide a stateless scheme with no error propagation. Moreover, as there is no complex calculation involved for compression and decompression as with context-based header compression and ROHC, the proposed scheme is relatively easy to implement for high-speed applications.

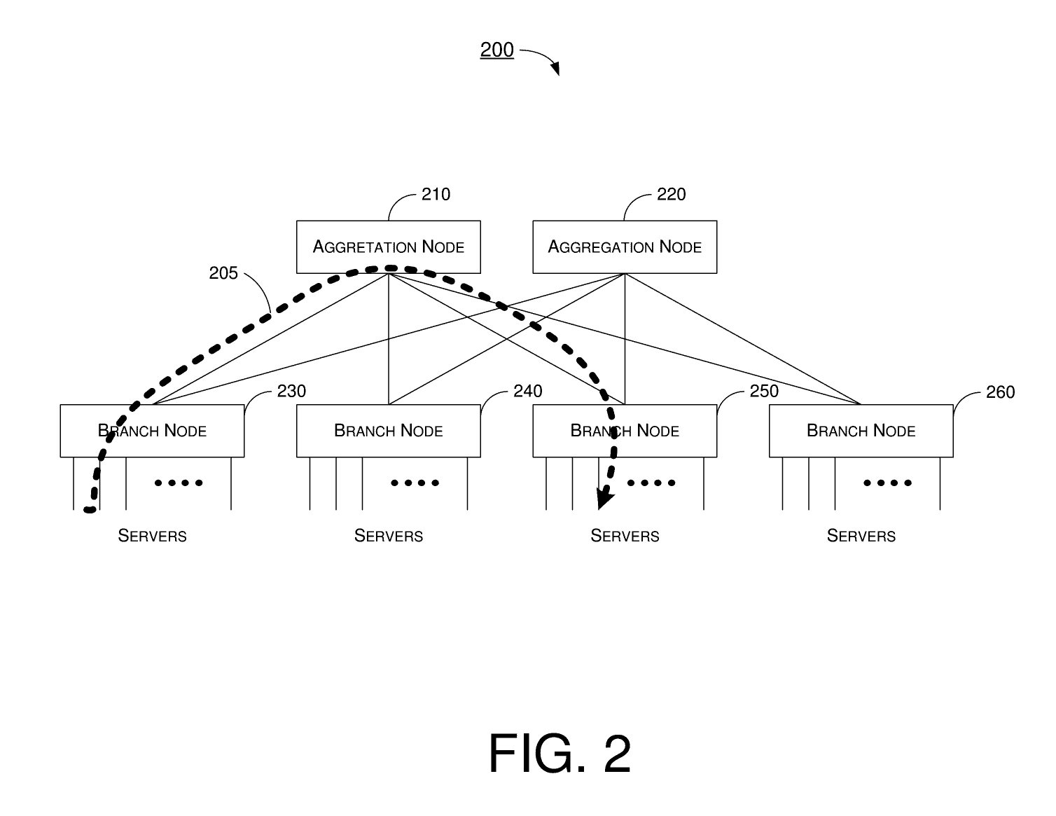

FIG. 2 illustrates an example network architecture 200 in which various techniques and schemes in accordance with the present disclosure may be implemented. Network architecture 200 may be implemented in data center networking and any other suitable types of networks. Network architecture 200 may include a number of branch nodes, such as branch nodes 230, 240, 250 and 260 shown in FIG. 2, each of which connected to plural computing devices such as servers. Network architecture 200 may also include a number of aggregation nodes, such as aggregation nodes 210 and 220, each of which connected to at least a portion of the branch nodes. In the example shown in FIG. 2, each of aggregation nodes 210 and 220 is connected to each of branch nodes 230, 240, 250 and 260. The concept of an architecture with branch nodes and aggregation nodes may be similar to that of leaf-spine architecture in some DCNs.

In the example shown in FIG. 2, a traffic or stream of data packets is routed via a path 205 from a server connected to branch node 230 to a server connected to branch node 250 through aggregation node 210. According to the present disclosure, data packets in the stream may be deflated at the beginning of path 205, e.g., by branch node 230, and inflated (or un-deflated) at the end of path 205, e.g., by branch node 250. Advantageously, this may result in bandwidth saving in the traffic along path 205 as well as saving in packet buffer for each, some or all of the network nodes along path 205, including branch node 230, aggregation node 210 and branch node 250.

### Example Implementations

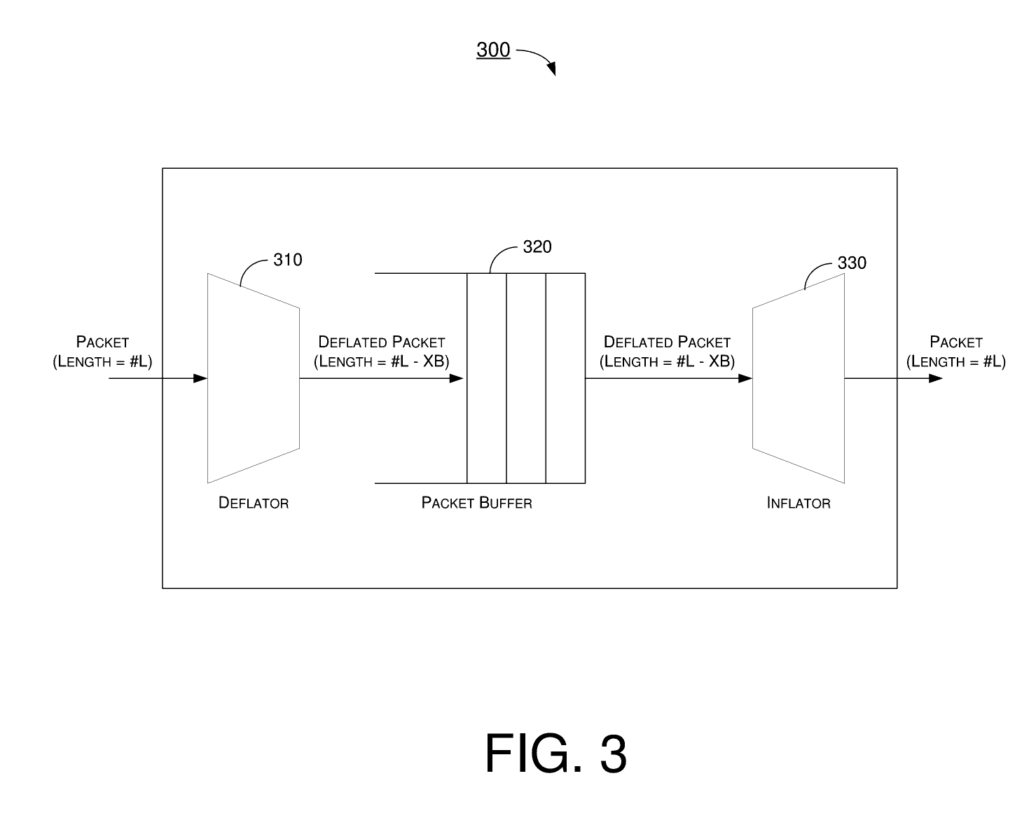

FIG. 3 illustrates an example apparatus in accordance with an implementation of the present disclosure. Apparatus 300 may be configured to implement scenario 100 and network architecture 200 described above as well as scenarios 400-600 and processes 700 and 800 described below. In some applications, apparatus 300 may be implemented in the form of a network node (e.g., switch or router) such as, for example and not limited to, each or any of aggregation nodes 210 and 220 as well as branch nodes 230, 240, 250 and 260. In some applications, apparatus 300 may be implemented in the form of one single integrated-circuit (IC) chip, multiple IC chips or a chipset, and such chip(s) may be employed in a networking node (e.g., switch or router) such as, for example and not limited to, each or any of aggregation nodes 210 and 220 as well as branch nodes 230, 240, 250 and 260. Apparatus 300 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, apparatus 300 is a special-purpose machine specifically designed, arranged and configured to perform specific tasks pertaining to packet header deflation for network virtualization in accordance with various embodiments of the present disclosure. Apparatus 300 may include one, some or all of those components shown in FIG. 3. Apparatus 300 may also include one or more other components that are not necessary relevant to the scope of the present disclosure. Therefore, to avoid obscuring the concept intended to be conveyed herein, such one or more other components of apparatus 300 are not shown in FIG. 3.

Apparatus 300 may include a packet header deflation circuit 310 (labeled as “deflator” in FIG. 3) and a packet buffer (labeled as “packet buffer” in FIG. 3). Packet buffer 320 may be coupled to receive data packets, whether deflated or not, from packet header deflation circuit 310 and store the received data packets therein.

Packet header deflation circuit 310 may be configured to perform a number pf operations. For instance, packet header deflation circuit 310 may receive (e.g., from a packet buffer or a network node) a first data packet having a first length (shown as “#L” in FIG. 3). Packet header deflation circuit 310 may abbreviate a header of the first data packet to deflate the first data packet into a first deflated data packet having a second length (shown as “#L−XB” in FIG. 3) shorter than the first length. Packet header deflation circuit 310 may then forward the first deflated data packet (e.g., to packet buffer 320 for storage or to another network node for forwarding).

In some implementations, in abbreviating the header of the first data packet to deflate the first data packet, packet header deflation circuit 310 may be configured to insert a profile field in a header of the deflated data packet. The profile field may indicate a profile of the data packet based on which the data packet is deflated.

Additionally or alternatively, in abbreviating the header of the first data packet to deflate the first data packet, packet header deflation circuit 310 may be configured to remove one or more static fields from the header of the deflated data packet.

Additionally or alternatively, in abbreviating the header of the first data packet to deflate the first data packet, packet header deflation circuit 310 may be configured to remove a checksum field from the header of the first data packet.

Additionally or alternatively, in abbreviating the header of the first data packet to deflate the first data packet, packet header deflation circuit 310 may be configured to replace an inner OUI field in an inner header of the header of the first data packet, which may have a first number of bits, with an encoded inner identifier field having a second number of bits less than the first number of bits. Moreover, packet header deflation circuit 310 may be also configured to replace an outer OUI field in an outer header of the header of the first data packet, which may have a third number of bits, with an encoded outer identifier field having a fourth number of bits less than the third number of bits.

Additionally or alternatively, when the first data packet is forwarded for L3 routing, in abbreviating the header of the first data packet to deflate the first data packet, packet header deflation circuit 310 may be configured to replace an inner OUI field in an inner header of the header of the first data packet, which may have a first number of bits, with an encoded inner identifier field having a second number of bits less than the first number of bits. Moreover, packet header deflation circuit 310 may be also configured to remove an outer OUI field from an outer header of the header of the first data packet.

In lieu of or in addition to packet header deflation circuit 310, apparatus 300 may include a packet header inflation circuit 330 (labeled as “inflator” in FIG. 3). Packet header inflation circuit 330 may be configured to perform a number of operations. For instance, packet header inflation circuit 330 may receive (e.g., from packet buffer 320 or a network node) a second deflated data packet having a third length (shown as “#L−XB” in FIG. 3). Packet header inflation circuit 330 may restore a header of the second deflated data packet to inflate the second deflated data packet into an un-deflated data packet having a fourth length (shown as “#L” in FIG. 3) longer than the third length. Packet header inflation circuit 330 may then forward the un-deflated data packet (e.g., to a packet buffer for storage or to another network node for forwarding).

In some implementations, in restoring the header of the second deflated data packet to inflate the second deflated data packet, packet header inflation circuit 330 may be configured to remove a profile field from the header of the second deflated data packet. The profile field may indicate a profile of the data packet based on which the data packet was deflated.

Additionally or alternatively, in restoring the header of the second deflated data packet to inflate the second deflated data packet, packet header inflation circuit 330 may be configured to insert one or more static fields into the header of the second deflated data packet.

Additionally or alternatively, in restoring the header of the second deflated data packet to inflate the second deflated data packet, packet header inflation circuit 330 may be configured to insert a checksum field into the header of the second deflated data packet.

Additionally or alternatively, in restoring the header of the second deflated data packet to inflate the second deflated data packet, packet header inflation circuit 330 may be configured to replace an encoded inner identifier field in an inner field of the header of the second deflated data, which may have a second number of bits, with an inner OUI field having a first number of bits greater than the second number of bits. Moreover, packet header inflation circuit 330 may be also configured to replace an encoded outer identifier field in the outer header and having a fourth number of bits with an outer OUI field having a third number of bits greater than the fourth number of bits.

Additionally or alternatively, when the second deflated data packet is forwarded for L3 routing, in restoring the header of the second deflated data packet to inflate the second deflated data packet, packet header inflation circuit 330 may be configured to replace an encoded inner identifier field in an inner field of the header of the second deflated data packet, which may have a second number of bits, with an inner OUI field having a first number of bits greater than the second number of bits. Furthermore, packet header inflation circuit 330 may be also configured to insert an outer OUI field into an outer header of the header of the second deflated data packet.

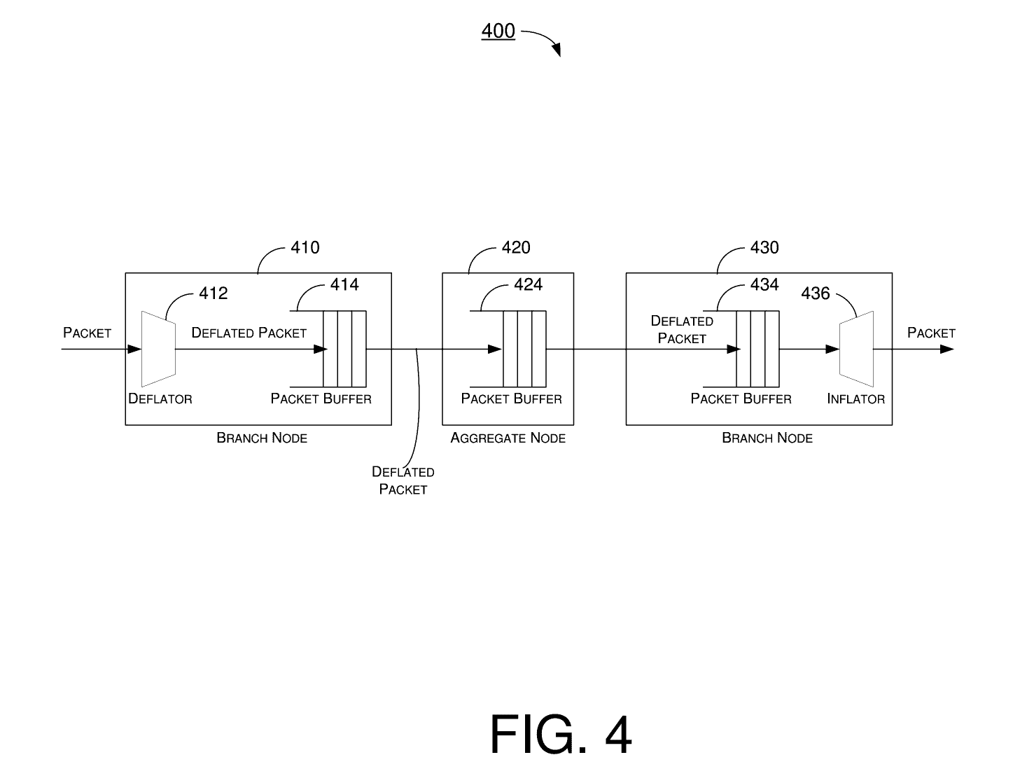

FIG. 4 illustrates an example scenario 400 in accordance with an implementation of the present disclosure. Scenario 400 may include network nodes (e.g., switches and/or routers) 410, 420 and 430. In the context of network architecture 200, network node 410 may be an example implementation of branch node 230, network node 420 may be an example implementation of aggregation node 210, and network node 430 may be an example implementation of branch node 250. Each of network nodes 410, 420 and 430 may be configured with one or more components similar to those of apparatus 300 to provide corresponding functionalities.

As shown in FIG. 4, network node 410 includes a deflator 412 and a packet buffer 414, network node 420 includes a packet buffer 424, and network node 430 includes a packet buffer 434 and an inflator 436. Deflator 412 may be an example implementation of packet header deflation circuit 310, and thus may be configured to perform operations described above with respect to packet header deflation circuit 310. Each of packet buffers 414, 424 and 434 may be an example implementation of packet buffer 320, and thus may be configured to perform operations described above with respect to packet buffer 320. Inflator 436 may be an example implementation of packet header inflation circuit 330, and thus may be configured to perform operations described above with respect to packet header inflation circuit 330.

In scenario 400, a stream of data packets may be received (e.g., from a server) by deflator 412 of network node 410, which deflates or otherwise abbreviates the header of one or more of the data packets in the stream. The data packets, some or all of which being deflated, are buffered in packet buffer 414 before being forwarded from network node 410 to network node 420. Next, the data packets, some or all of which being deflated, are buffered in packet buffer 424 before being forwarded from network node 420 to network node 430. Subsequently, the data packets, some or all of which being deflated, are buffered in packet buffer 434 before being inflated or otherwise restored by inflator 436. The un-deflated or otherwise restored data packets are then transmitted by network node 430 for further forwarding or to a destination (e.g., another server).

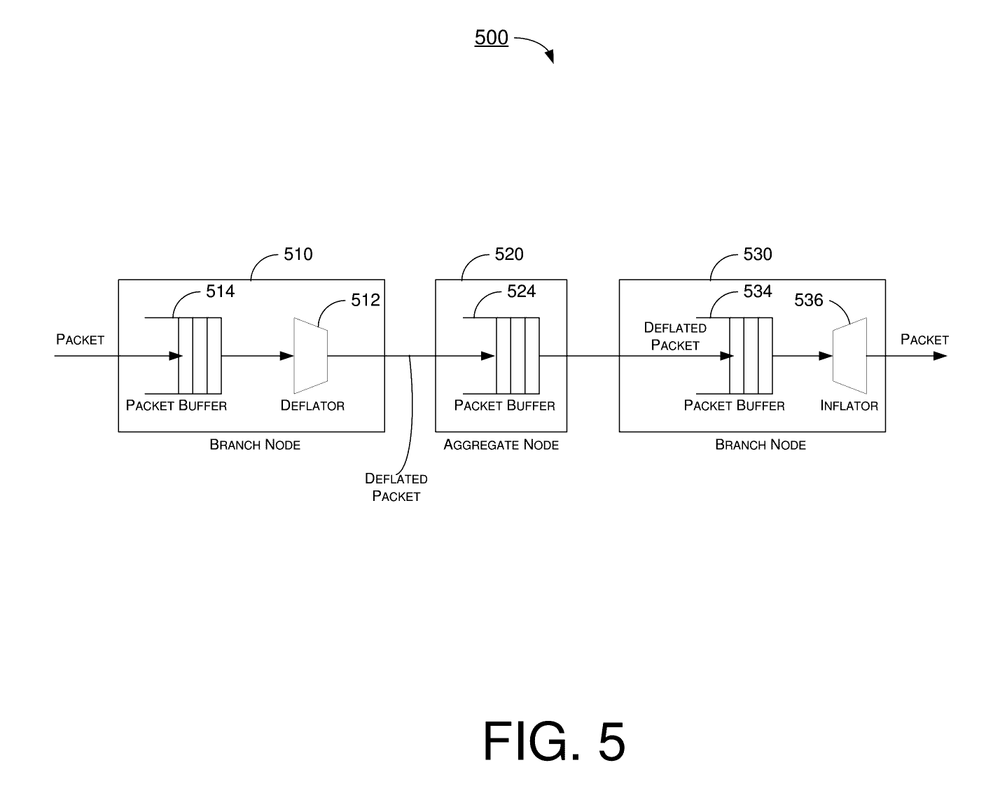

FIG. 5 illustrates an example scenario 500 in accordance with another implementation of the present disclosure. Scenario 500 may include network nodes (e.g., switches and/or routers) 510, 520 and 530. In the context of network architecture 200, network node 510 may be an example implementation of branch node 230, network node 520 may be an example implementation of aggregation node 210, and network node 530 may be an example implementation of branch node 250. Each of network nodes 510, 520 and 530 may be configured with one or more components similar to those of apparatus 300 to provide corresponding functionalities.

As shown in FIG. 5, network node 510 includes a deflator 512 and a packet buffer 514, network node 520 includes a packet buffer 524, and network node 530 includes a packet buffer 534 and an inflator 536. Deflator 512 may be an example implementation of packet header deflation circuit 310, and thus may be configured to perform operations described above with respect to packet header deflation circuit 310. Each of packet buffers 514, 524 and 534 may be an example implementation of packet buffer 320, and thus may be configured to perform operations described above with respect to packet buffer 320. Inflator 536 may be an example implementation of packet header inflation circuit 330, and thus may be configured to perform operations described above with respect to packet header inflation circuit 330.

In scenario 500, a stream of data packets may be received (e.g., from a server) and buffered by packet buffer 514 of network node 510 before reaching deflator 512, which deflates or otherwise abbreviates the header of one or more of the data packets in the stream. Afterwards, the data packets, some or all of which being deflated, are forwarded from network node 510 to network node 520. Next, the data packets, some or all of which being deflated, are buffered in packet buffer 524 before being forwarded from network node 520 to network node 530. Subsequently, the data packets, some or all of which being deflated, are buffered in packet buffer 534 before being inflated or otherwise restored by inflator 536. The un-deflated or otherwise restored data packets are then transmitted by network node 530 for further forwarding or to a destination (e.g., another server).

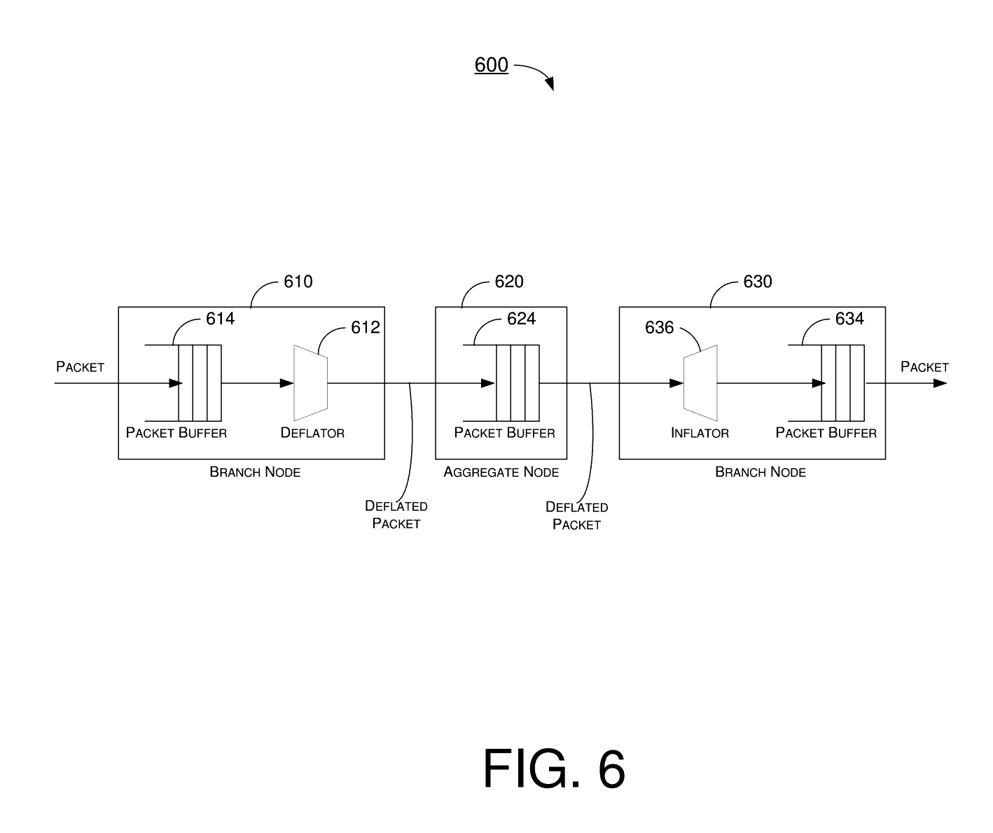

FIG. 6 illustrates an example scenario 600 in accordance with yet another implementation of the present disclosure. Scenario 600 may include network nodes (e.g., switches and/or routers) 610, 620 and 630. In the context of network architecture 200, network node 610 may be an example implementation of branch node 230, network node 620 may be an example implementation of aggregation node 210, and network node 630 may be an example implementation of branch node 250. Each of network nodes 610, 620 and 630 may be configured with one or more components similar to those of apparatus 300 to provide corresponding functionalities.

As shown in FIG. 6, network node 610 includes a deflator 612 and a packet buffer 614, network node 620 includes a packet buffer 624, and network node 630 includes a packet buffer 634 and an inflator 636. Deflator 612 may be an example implementation of packet header deflation circuit 310, and thus may be configured to perform operations described above with respect to packet header deflation circuit 310. Each of packet buffers 614, 624 and 634 may be an example implementation of packet buffer 320, and thus may be configured to perform operations described above with respect to packet buffer 320. Inflator 636 may be an example implementation of packet header inflation circuit 330, and thus may be configured to perform operations described above with respect to packet header inflation circuit 330.

In scenario 600, a stream of data packets may be received (e.g., from a server) and buffered by packet buffer 614 of network node 610 before reaching deflator 612, which deflates or otherwise abbreviates the header of one or more of the data packets in the stream. Afterwards, the data packets, some or all of which being deflated, are forwarded from network node 610 to network node 620. Next, the data packets, some or all of which being deflated, are buffered in packet buffer 624 before being forwarded from network node 620 to network node 630. Subsequently, the data packets, some or all of which being deflated, are inflated or otherwise restored by inflator 536. The un-deflated or otherwise restored data packets are then buffered by packet buffer 634 of network node 630 before being forwarded for further forwarding or to a destination (e.g., another server).

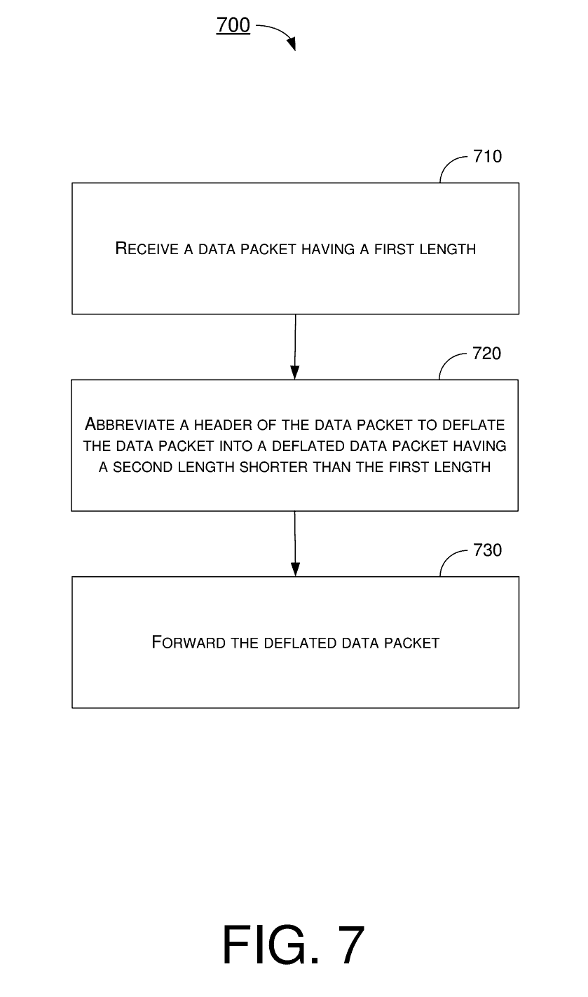

FIG. 7 illustrates an example process 700 in accordance with an implementation of the present disclosure. Process 700 may include one or more operations, actions, or functions as represented by one or more of blocks 710, 720 and 730. Although illustrated as discrete blocks, various blocks of process 700 may be divided into additional blocks, combined into fewer blocks, or eliminated, depending on the desired implementation. The blocks of process 700 may be performed in the order shown in FIG. 7 or in any other order, depending on the desired implementation. Process 700 may be implemented by apparatus 300, apparatus 410, apparatus 510 and/or apparatus 610, and process 700 may be implemented in a network architecture such as network architecture 200 or any variations thereof. Solely for illustrative purpose and without limiting the scope of the present disclosure, process 700 is described below in the context of process 700 being performed by apparatus 610. Process 700 may begin at 710.

At 710, process 700 may involve apparatus 610 receiving a data packet having a first length. Process 700 may proceed from 710 to 720.

At 720, process 700 may involve apparatus 610 abbreviating a header of the data packet to deflate the data packet into a deflated data packet having a second length shorter than the first length. Process 700 may proceed from 720 to 730.

At 730, process 700 may involve apparatus 610 forwarding the deflated data packet (e.g., to apparatus 620 as shown in FIG. 6).

In some implementations, in abbreviating the header of the data packet to deflate the data packet, process 700 may involve apparatus 610 removing one or more static fields from the header of the data packet and inserting a profile field into the header of the deflated data packet. The profile field may indicate a profile of the data packet based on which the data packet is deflated.

In some implementations, in abbreviating the header of the data packet to deflate the data packet, process 700 may also involve apparatus 610 removing a checksum field from the header of the data packet.

In some implementations, the header of the data packet may include an inner header and an outer header. In such cases, in abbreviating the header of the data packet to deflate the data packet, process 700 may involve apparatus 610 replacing an inner OUI field in the inner header and having a first number of bits with an encoded inner identifier field having a second number of bits less than the first number of bits. Moreover, process 700 may also involve apparatus 610 replacing an outer OUI field in the outer header and having a third number of bits with an encoded outer identifier field having a fourth number of bits less than the third number of bits.

In some implementations, the header of the data packet may include an inner header and an outer header. In such cases, in abbreviating the header of the data packet to deflate the data packet, process 700 may involve apparatus 610 replacing an inner OUI field in the inner header and having a first number of bits with an encoded inner identifier field having a second number of bits less than the first number of bits. Additionally, process 700 may also involve apparatus 610 removing an outer OUI field from the outer header.

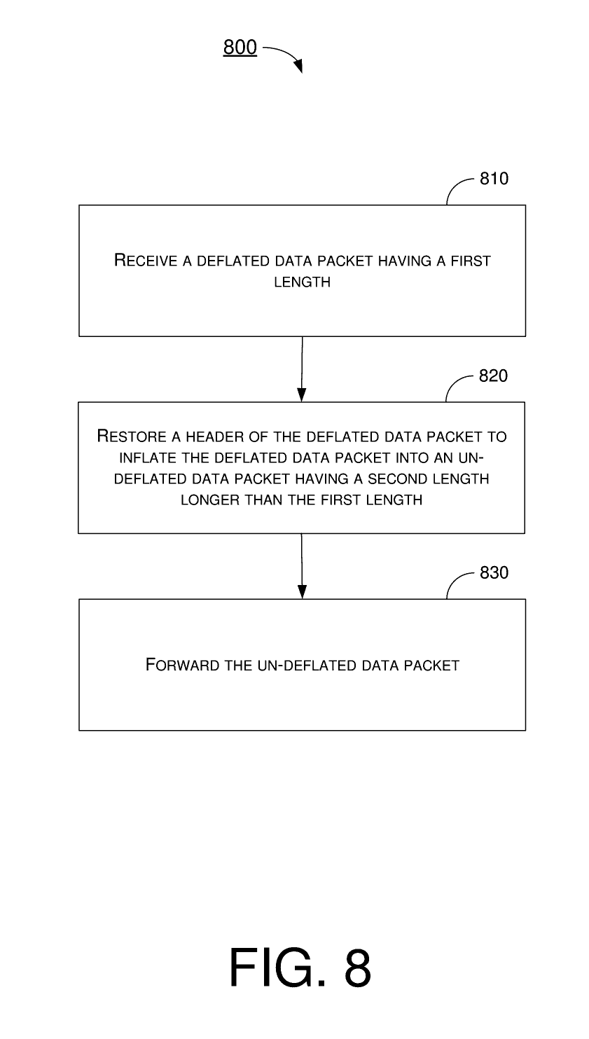

FIG. 8 illustrates an example process 800 in accordance with an implementation of the present disclosure. Process 800 may include one or more operations, actions, or functions as represented by one or more of blocks 810, 820 and 830. Although illustrated as discrete blocks, various blocks of process 800 may be divided into additional blocks, combined into fewer blocks, or eliminated, depending on the desired implementation. The blocks of process 800 may be performed in the order shown in FIG. 8 or in any other order, depending on the desired implementation. Process 800 may be implemented by apparatus 300, apparatus 430, apparatus 530 and/or apparatus 630, and process 800 may be implemented in a network architecture such as network architecture 200 or any variations thereof. Solely for illustrative purpose and without limiting the scope of the present disclosure, process 800 is described below in the context of process 800 being performed by apparatus 630. Process 800 may begin at 810.

At 810, process 800 may involve apparatus 630 receiving a deflated data packet having a first length. Process 800 may proceed from 810 to 820.

At 820, process 800 may involve apparatus 630 restoring a header of the deflated data packet to inflate the deflated data packet into an un-deflated data packet having a second length longer than the first length. Process 800 may proceed from 820 to 830.

At 830, process 800 may involve apparatus 630 forwarding the un-deflated data packet.

In some implementations, in restoring the header of the deflated data packet to inflate the deflated data packet, process 800 may involve apparatus 630 removing a profile field from the header of the deflated data packet. The profile field may indicate a profile of the data packet based on which the data packet was deflated. Moreover, process 800 may involve apparatus 630 inserting one or more static fields into the header of the deflated data packet.

In some implementations, in restoring the header of the deflated data packet to inflate the deflated data packet, process 800 may also involve apparatus 630 inserting a checksum field into the header of the deflated data packet.

In some implementations, the header of the deflated data packet may include an inner header and an outer header. In such cases, in restoring the header of the deflated data packet to inflate the deflated data packet, process 800 may involve apparatus 630 replacing an encoded inner identifier field in the inner field and having a second number of bits with an inner OUI having a first number of bits greater than the second number of bits. Additionally, process 800 may involve apparatus 630 replacing an encoded outer identifier field in the outer header and having a fourth number of bits with an outer OUI field having a third number of bits greater than the fourth number of bits.

In some implementations, the header of the deflated data packet may include an inner header and an outer header. In such cases, in restoring the header of the deflated data packet to inflate the deflated data packet, process 800 may involve apparatus 630 replacing an encoded inner identifier field in the inner field and having a second number of bits with an inner OUI having a first number of bits greater than the second number of bits. Furthermore, process 800 may involve apparatus 630 inserting an outer OUI field into the outer header.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “ a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “ a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving a data packet having a first length;
abbreviating a header of the data packet to deflate the data packet into a deflated data packet having a second length shorter than the first length; and
forwarding the deflated data packet.

2. The method of claim 1, wherein the abbreviating of the header of the data packet to deflate the data packet comprises:
inserting a profile field in a header of the deflated data packet, the profile field indicating a profile of the data packet based on which the data packet is deflated; and
removing one or more static fields from the header of the deflated data packet.

3. The method of claim 2, wherein the abbreviating of the header of the data packet to deflate the data packet further comprises removing a checksum field from the header of the data packet.

4. The method of claim 2, wherein the header of the data packet comprises an inner header and an outer header, and wherein the abbreviating of the header of the data packet to deflate the data packet comprises:
replacing an inner Organizationally Unique Identifier (OUI) field in the inner header and having a first number of bits with an encoded inner identifier field having a second number of bits less than the first number of bits; and
replacing an outer OUI field in the outer header and having a third number of bits with an encoded outer identifier field having a fourth number of bits less than the third number of bits.

5. The method of claim 2, wherein the header of the data packet comprises an inner header and an outer header, and wherein the abbreviating of the header of the data packet to deflate the data packet comprises:
replacing an inner Organizationally Unique Identifier (OUI) field in the inner header and having a first number of bits with an encoded inner identifier field having a second number of bits less than the first number of bits; and
removing an outer OUI field from the outer header.

6. A method, comprising:
receiving a deflated data packet having a first length;
restoring a header of the deflated data packet to inflate the deflated data packet into an un-deflated data packet having a second length longer than the first length; and
forwarding the un-deflated data packet.

7. The method of claim 7, wherein the restoring of the header of the deflated data packet to inflate the deflated data packet comprises:
removing a profile field from the header of the deflated data packet, and wherein the profile field indicates a profile of the data packet based on which the data packet was deflated; and
inserting one or more static fields into a header of the deflated data packet.

8. The method of claim 7, wherein restoring of the header of the deflated data packet to inflate the deflated data packet further comprises inserting a checksum field into the header of the deflated data packet.

9. The method of claim 7, wherein the header of the deflated data packet comprises an inner header and an outer header, and wherein the restoring of the header of the deflated data packet to inflate the deflated data packet comprises:
replacing an encoded inner identifier field in the inner field and having a second number of bits with an inner Organizationally Unique Identifier (OUI) field having a first number of bits greater than the second number of bits; and
replacing an encoded outer identifier field in the outer header and having a fourth number of bits with an outer OUI field having a third number of bits greater than the fourth number of bits.

10. The method of claim 7, wherein the header of the data packet comprises an inner header and an outer header, and wherein the restoring of the header of the deflated data packet to inflate the deflated data packet comprises:
replacing an encoded inner identifier field in the inner field and having a second number of bits with an inner Organizationally Unique Identifier (OUI) field having a first number of bits greater than the second number of bits; and
inserting an outer OUI field into the outer header.

11. An apparatus, comprising:
a packet header deflation circuit capable of performing operations comprising:
receiving a first data packet having a first length;
abbreviating a header of the first data packet to deflate the first data packet into a first deflated data packet having a second length shorter than the first length; and
forwarding the first deflated data packet; and
a buffer capable of storing either the first data packet or the first deflated data packet.

12. The apparatus of claim 11, wherein, in abbreviating the header of the first data packet to deflate the first data packet, the packet header deflation circuit is further capable of performing operations comprising:
inserting a profile field in a header of the deflated data packet, the profile field indicating a profile of the data packet based on which the data packet is deflated; and
removing one or more static fields from the header of the deflated data packet.

13. The apparatus of claim 12, wherein, in abbreviating the header of the first data packet to deflate the first data packet, the packet header deflation circuit is further capable of removing a checksum field from the header of the first data packet.

14. The apparatus of claim 12, wherein the header of the first data packet comprises an inner header and an outer header, and wherein, in abbreviating the header of the first data packet to deflate the first data packet, the packet header deflation circuit further capable of performing operations comprising:
replacing an inner Organizationally Unique Identifier (OUI) field in the inner header and having a first number of bits with an encoded inner identifier field having a second number of bits less than the first number of bits; and
replacing an outer OUI field in the outer header and having a third number of bits with an encoded outer identifier field having a fourth number of bits less than the third number of bits.

15. The apparatus of claim 12, wherein the header of the first data packet comprises an inner header and an outer header, and wherein, in abbreviating the header of the first data packet to deflate the first data packet, the packet header deflation circuit is further capable of performing operations comprising:
replacing an inner Organizationally Unique Identifier (OUI) field in the inner header and having a first number of bits with an encoded inner identifier field having a second number of bits less than the first number of bits; and
removing an outer OUI field from the outer header.

16. The apparatus of claim 11, further comprising a packet header inflation circuit capable of performing operations comprising:
receiving a second deflated data packet having a third length;
restoring a header of the second deflated data packet to inflate the second deflated data packet into an un-deflated data packet having a fourth length longer than the third length; and
forwarding the un-deflated data packet.

17. The apparatus of claim 16, wherein, in restoring the header of the second deflated data packet to inflate the second deflated data packet, the packet header inflation circuit is further capable of performing operations comprising:
removing a profile field from the header of the second deflated data packet, wherein the profile field indicates a profile of the data packet based on which the data packet was deflated; and
inserting one or more static fields into the header of the second deflated data packet.

18. The apparatus of claim 16, wherein, in restoring the header of the second deflated data packet to inflate the second deflated data packet, the packet header inflation circuit is further capable of inserting a checksum field into the header of the second deflated data packet.

19. The apparatus of claim 16, wherein the header of the second deflated data packet comprises an inner header and an outer header, and wherein, in restoring the header of the second deflated data packet to inflate the second deflated data packet, the packet header inflation circuit is further capable of performing operations comprising:
replacing an encoded inner identifier field in the inner field and having a second number of bits with an inner Organizationally Unique Identifier (OUI) field having a first number of bits greater than the second number of bits; and
replacing an encoded outer identifier field in the outer header and having a fourth number of bits with an outer OUI field having a third number of bits greater than the fourth number of bits.

20. The apparatus of claim 16, wherein the header of the data packet comprises an inner header and an outer header, and wherein, in restoring the header of the second deflated data packet to inflate the second deflated data packet, the packet header inflation circuit is further capable of performing operations comprising:
replacing an encoded inner identifier field in the inner field and having a second number of bits with an inner Organizationally Unique Identifier (OUI) field having a first number of bits greater than the second number of bits; and
inserting an outer OUI field into the outer header.
